(19) United States
(12) Patent Application Publication
(10) Pub. No.: US 2026/0169807 A1
(43) Pub. Date: Jun. 18, 2026

(54) Optimized Resource Provisioning

(71) Applicant: CAST AI Group, Inc., Miami, FL (US)

(72) Inventors: Mantas Cepulkovskis, Vilnius (LT); Valdas Rakutis, Vilnius (LT); Laurynas Stasys, Vilnius (LT)

(21) Appl. No.: 19/080,682

(22) Filed: Mar. 14, 2025

Related U.S. Application Data
(60) Provisional application No. 63/730,992, filed on Dec. 12, 2024.

(51) Int. Cl. G06F 9/50

(52) U.S. Cl. CPC G06F 9/5027

(57) ABSTRACT

A system accesses time-series data representing resource consumption of a workload and decomposes the data into frequency components. The system identifies one or more top frequency components based on power magnitudes and determines an energy ratio based on the power magnitudes of the one or more top frequency components and a total power of the time series data. The system determines whether the energy ratio is greater than a predetermined threshold. In response to determining that the energy ratio is greater than the predetermined threshold, the system determines the workload exhibits seasonality. In response to determining that the workload exhibits seasonality, the system proactively provisions computing resources for the workload based on the seasonality.

### CROSS REFERENCE TO RELATED APPLICATION

This application claims priority to U.S. Provisional Patent Application Ser. No. 63/730,992, filed Dec. 12, 2024, which is incorporated herein by reference in its entirety.

### TECHNICAL FIELD

This disclosure relates generally to cloud computing, and more specifically to proactive compute resource management.

### BACKGROUND

Cloud computing environments, such as Kubernetes-managed infrastructures, rely on static and reactive resource allocation strategies to manage computational resources such as CPU and memory. In these systems, workloads experience fluctuations in demand over time, yet resource allocation decisions are typically made using conservative heuristics or threshold-based scaling mechanisms. These methods often lead to suboptimal resource utilization, either by reserving excessive capacity or failing to scale adequately during demand surges.

For example, certain workloads exhibit predictable fluctuations in resource demand, often following daily, weekly, or other seasonal cycles. For example, enterprise applications may experience higher resource utilization during business hours and significantly lower usage at night. Similarly, e-commerce platforms may encounter traffic spikes during promotional sales events, while the demand remains minimal during off-peak times. To accommodate such fluctuating demand, traditional resource allocation strategies rely on percentile-based provisioning, often at the 90^{th} or 85^{th} percentile of peak usage. This ensures that the system has adequate resources to handle most of the high-demand periods, but it results in significant over-provisioning during low-demand periods. In many cases, workloads operate at a fraction of their allocated capacity, leading to substantial waste of computing resources and increased infrastructure costs. Additionally, in cases where peak demand exceeds provisioned capacity, the system may experience under-provisioning, resulting in service degradation or failures.

### SUMMARY

The present disclosure relates to a system and method for proactive compute resource management in cloud computing environments. Traditional resource allocation strategies rely on reactive scaling mechanisms, which may lead to inefficient resource utilization due to under-provisioning (causing performance degradation) or over-provisioning (leading to resource waste).

The disclosed system and method enable seasonality aware forecasting of resource demand. The system accesses time-series data representing workload resource consumption and applies a transform to decompose the data into frequency components. Each frequency component corresponds to a power magnitude. The system then identifies one or more top frequency components based on their corresponding power magnitudes. The transform may include (but is not limited to) Fourier transform or any other methods that may be implemented to detect frequency components or features associated with seasonality.

The system determines an energy ratio based on the power magnitudes of the one or more top frequency components and a total power of the time series data, and determines whether the energy ratio is greater than a predetermined threshold. In response to determining that the energy ratio is greater than the predetermined threshold, the system determines that the workload exhibits seasonal behavior. If the energy ratio exceeds a predefined threshold, the workload is classified as seasonal, and future resource demand is forecasted based on seasonality.

Using the forecasted demand, the system proactively provisions computing resources to ensure optimal performance and cost efficiency. By dynamically adjusting resource allocation in anticipation of workload fluctuations, the system reduces latency, improves resource utilization, and enhances overall system reliability. The disclosed approach is adaptable to various cloud computing platforms, including Kubernetes-managed infrastructures, enabling efficient and automated workload scaling.

### BRIEF DESCRIPTION OF THE DRAWINGS

FIG. 1 is a block diagram of a system environment in which an automation system may be implemented, in accordance with one or more embodiments.

FIG. 2 illustrates an example architecture of a network resource allocation module in accordance with one or more embodiments.

FIG. 3A illustrates an example time-series plot of a workload CPU usage and a corresponding resource allocation recommendation generated by an existing optimization system, in accordance with one or more embodiments.

FIG. 3B illustrates another example time-series plot of a workload CPU usage and a corresponding resource allocation recommendation generated by the existing optimization system, in accordance with one or more embodiments.

FIGS. 4A-4E illustrate an example workload CPU usage time-series being divided into multiple frequency components, which can then be combined together to predict future workload CPU usage.

FIG. 5 illustrates another example time series of a workload with strong seasonality, such that the forecasting time series closely resembles the original time series, in accordance with one or more embodiments.

FIG. 6A illustrates a percentage under-provisioning difference between existing system and Chrono-based system across different percentiles.

FIG. 6B illustrates unit number under-provisioning difference between existing system and Chrono-based system across different percentile.

FIG. 6C illustrates percentage sMAPE (symmetric Mean Absolute Percentage Error) differences between existing system and Chrono-based system across different percentiles.

FIG. 6D illustrates percentage over-provisioning differences between existing system and Chrono-based system across different percentiles.

FIG. 6E illustrates unit number over-provisioning differences between existing system and Chrono-based system across different percentile.

FIG. 7A illustrates workload with intermittent CPU usage with sharp spikes and long idled periods.

FIG. 7B illustrates another highly dynamic workload, where CPU demand remains consistently high with some variations.

FIG. 8 is a table, presenting a quantitative evaluation of forecasting accuracy and resource allocation efficiency of the forecasting system described herein, comparing key performance metrics at different time periods, in accordance with one or more embodiments.

FIG. 9 is a flowchart of a method for proactively optimizing resource allocation based on seasonality in a cloud computing environment, in accordance with one or more embodiments.

FIG. 10 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Traditional cloud computing resource management systems primarily rely on static provisioning or reactive autoscaling mechanisms, which often lead to inefficient resource utilization. These systems typically allocate resources based on conservative heuristics or predefined thresholds, failing to account for seasonal workload patterns that exhibit predictable fluctuations over time. As a result, over-provisioning occurs when excess computing resources are allocated during low-demand periods, leading to unnecessary operational inefficiencies and infrastructure waste. Conversely, under-provisioning happens when resource allocation fails to meet peak demand, causing performance degradation, increased latency, or even system failures. Additionally, existing autoscaling techniques react to changes after they occur, introducing delays in scaling decisions that may result in service disruptions or inefficient response to sudden spikes in demand. Without a predictive, seasonality-aware approach, current methods struggle to balance performance, resource consumption efficiency, and adaptability in dynamic cloud environments, limiting their effectiveness in optimizing cloud resource management.

Embodiments described herein address the above-described issues by introducing a predictive resource management system for cloud computing environments that dynamically adjusts computing resources based on seasonality-aware forecasting. The system collects time-series data representing resource consumption of workloads and applies a transformation (e.g., Fourier transform) to decompose the data into frequency components. By identifying dominant frequency components and computing an energy ratio, the system determines whether a workload exhibits seasonal behavior. If the energy ratio exceeds a predetermined threshold, the system classifies the workload as seasonal and forecasts future resource demand based on recurring patterns. Using this forecast, the system proactively provisions computing resources in advance, ensuring optimal performance while minimizing under-provisioning (which leads to performance degradation) and over-provisioning (which results in wasted resources). This predictive approach improves scalability and resource consumption efficiency in cloud environments, making it adaptable for Kubernetes-managed infrastructures and other cloud-based platforms.

Notably, the Fourier transform is one method that can be implemented to detect seasonality in workload resource consumption data. However, this is merely an example of one approach, and other techniques may be employed for seasonality detection. For example, wavelet transforms, autoregressive integrated moving average (ARIMA) models, seasonal decomposition of time series (STL), or other statistical and machine learning-based methods may also be used to identify recurring patterns in workload behavior. Similarly, while the disclosed embodiments discuss the use of transformer-based time-series models and inverse Fourier transforms for forecasting, alternative models such as long short-term memory (LSTM) networks, Gaussian processes, or exponential smoothing methods may be employed. A person of ordinary skill in the art would recognize that various techniques can be adapted based on the nature of the workload data and the specific cloud computing environment.

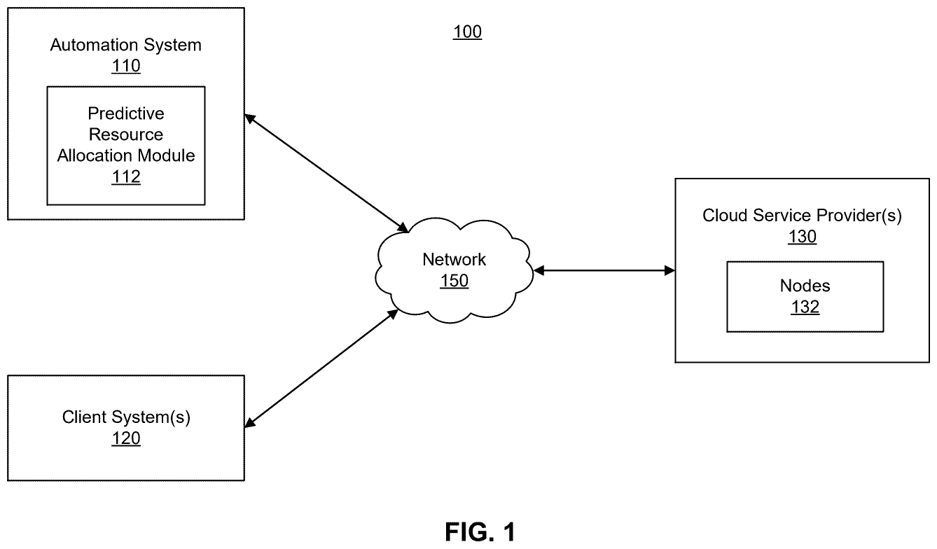

Additional details about the system are further described below with respect to FIGS. 1-9.

### System Architecture

FIG. 1 is a block diagram of a system environment 100 in which an automation system 110 (also referred to “the system”) may be implemented in accordance with one or more embodiments. The environment 100 includes the automation system 110, one or more client devices 120, and one or more cloud service provider(s) 130, all interconnected via a network 150. The cloud service provider(s) 130 host one or more nodes 132, which may be virtual machines (VMs). The cloud service provider(s) 130 may include (but are not limited to) Amazone Web Services (AWS)®, Google Cloud Platform (GCP)®, and/or Microsoft Azure®. The cloud service provider 130 provides computing resources, such as VMs, storage, and networking, over the network 150. VMs are scalable, software-based representations of physical machines that can run operating systems and applications. Networking includes virtualized network components, such as firewalls, and virtual private networks (VPNs). These resources may be made available to users on-demand, enabling flexibility and scalability. In some embodiments, the nodes 132 are part of a Kubernetes cluster, which is a distributed system for managing containerized applications across multiple VMs. Additional details about clusters and Kubernetes services are described in U.S. patent application Ser. No. 17/380,729, filed Jul. 20, 2021 (now issued as U.S. Pat. No. 11,595,306), which is incorporated herein in its entirety.

The automation system 110 includes a predictive resource allocation module 112, which is configured to determine under- and over-provisioning of CPUs, identify workloads that exhibit seasonal patterns, and predict future resource consumption for these workloads. This prediction can then be used to proactively provision additional compute resources in time to prevent spikes or to deprovision compute resources to avoid idling.

In some embodiments, the predictive resource allocation module 112 analyzes historical workload data to determine metrics related to over-provisioning and under-provisioning of compute resources, such as CPU (central processing unit), GPU (graphics processing unit), memory, disk I/O (input/output), and/or network bandwidth. Under-provisioning occurs when a system is allocated insufficient compute resources, leading to performance bottlenecks, slow processing, or system failures. Conversely, over-provisioning occurs when excess compute resources are allocated, resulting in idle resources and increased inefficiencies. The predictive resource allocation module 112 evaluates these metrics over time to identify workloads that exhibit seasonal patterns. For example, some workloads have seasonal fluctuations in CPU demand: business applications may experience high CPU usage during business hours, while e-commerce platforms may peak during holidays or flash sales.

In some embodiments, the predictive resource allocation module 112 identifies seasonal patterns using Fourier Transform. Fourier Transform is applied to workload metrics to convert time-series data into its frequency components. In response to determining that at least one frequency component exceeds a predetermined threshold, the predictive resource allocation module 112 classifies the corresponding workload as exhibiting a seasonal pattern. Otherwise, the predictive resource allocation module 112 determines that the workload does not exhibit a seasonal pattern.

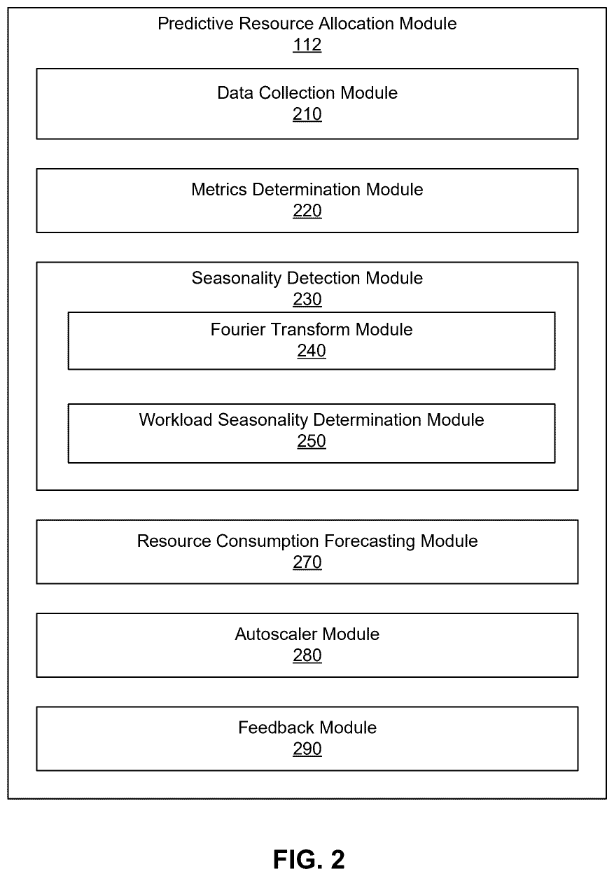

Based on the identified seasonal patterns, the predictive resource allocation module 112 can then predict future resource consumption. In some embodiments, the values of the frequency components are used to predict future resource consumption. In other embodiments, a time-series forecasting model (e.g., transformer-based time-series forecasting model), can be employed to generate predictions. In response to predicting a future increase in compute resource demand, the predictive resource allocation module 112 automatically provisions additional resources before a spike occurs. This prevents system slowdowns, reduces latency, and ensures high availability. Conversely, in response to predicting a decline in CPU demand, the predictive resource allocation module 112 deallocates unused resources to prevent infrastructure idling. This enhances resource utilization efficiency while ensuring that resources remain available when needed. Additional details about the predictive resource allocation module 112 are further described below with respect to FIGS. 2-9.

The client device(s) 120 are computing systems associated with various entities. These entities include entities that can provision nodes 132 on the cloud service provider 130, as well as end-users who engage with applications deployed onto the nodes 132. The client devices 120 are also capable of receiving user input as well as transmitting and/or receiving data via the network 150. In one embodiment, a client device 120 is a computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 150. In one embodiment, a client device 120 executes an application allowing a user of the client device 120 to interact with the automation system 110. For example, the client device 120 may execute a customer mobile application to enable interaction between the client device 120 and the automation system 110 or the cloud service providers 130. As another example, a client device 120 executes a browser application to enable interaction between the client device 120 and the system 110 via the network 150. In another embodiment, a client device 120 interacts with the system 110 through an application programming interface (API) running on a native operating system of the client device 120, such as IOS® or ANDROID™.

The network 150 is configured to facilitate communications among the automation system 110, client device 120, and cloud service provider 130. The network 150 may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Example Architecture of the Predictive Resource Allocation Module

FIG. 2 illustrates an example architecture of a predictive resource allocation module 112, in accordance with one or more embodiments. The predictive resource allocation module 112 includes a data collection module 210, a metrics determination module 220, a seasonality detection module 230, a resource consumption forecasting module 270, an autoscaler module 280, and a feedback module 290. In some embodiments, there may be additional or fewer modules than those illustrated in FIG. 2. Additionally, the functionalities of these modules may be redistributed, multiple modules may be combined into a single module, and/or a single module's functionalities may be divided into multiple modules.

The data collection module 210 is configured to collect resource consumption data. In some embodiments, the resource consumption data may be collected via Prometheus queries that monitor Kubernetes workloads. The data may include (but is not limited to) CPU consumption, memory consumption, disk I/O, and/or network bandwidth at pod level. The data collection module 210 aggregates the data and structures the data into time series format. A time series format refers to a data structure that stores data points that are collected or recorded over time at sequential intervals. Each data point in a time series is associated with a specific timestamp, making it ideal for analyzing trends, patterns, and periodic behaviors. In some embodiments, the data collection module 210 generates a data point in the time series periodically, such as every a few seconds, every minute, every a few minutes, etc. For example, each data point may represent a CPU usage percentage during a predetermined time window (e.g., 5 minutes, 10 minutes or 15 minutes). Similarly, different time series may be generated for different resource consumption data points.

The seasonality detection module 230 is configured to analyze metrics of workloads or pods to detect seasonality. The seasonality detection module 230 includes a Fourier transform module 240 and a workload seasonality determination module 250. The Fourier transform module 240 is configured to convert a time series metrics (e.g., a CPU usage pattern over time, over-provisioning percentage over time, or under-provisioning percentage over time) into multiple frequency components. Any periodic signal (e.g., fluctuating resource usage) can be represented as a sum of sine and cosine waves of different frequencies. The Fourier transform module 240 can identify a set of frequencies from any given time series metrics. Notably, for some metrics, there is no seasonality or very weak seasonality, the frequency components may expand in a wide spectrum and power of each frequency components is very low.

Various algorithms may be implemented by the Fourier transform module 240 to perform Fourier transform to convert time series data into frequency components. Such algorithms may include (but are not limited to) discrete Fourier transform (DFT), fast Fourier transform (FFT), Goertzel algorithm, short-time Fourier transform (STFT), fast Hartley transform (FHT), modified discrete cosine transform (MDCT), Stockham Auto-sort FFT, parallel FFT, recursive FFT, quantum Fourier transform (QFT), among others.

The workload seasonality determination module 250 is configured to analyze the frequency components identified by the Fourier transform module 240 to determine whether the workload exhibits seasonality. Each frequency component corresponds to a power magnitude. In some embodiments, the workload seasonality determination module 250 sorts the frequency components by amplitude and identifies the frequency components with amplitudes greater than a threshold value as dominant frequency components. Alternatively, a top predetermined number (e.g., top 3) of frequency components are deemed as dominant frequency components. The workload seasonality determination module 250 also determines whether these identified dominant frequency components are sufficiently strong to indicate seasonality rather than noise. In some embodiments, the workload seasonality determination module 250 may determine how much of a total signal energy is concentrated in dominant frequency components, which may be represented by Equation (5) below:

$$Energy Ratio = \frac{{\sum }_{i ∈ {S}_{N}} {\vert {A}_{i} \vert}^{2}}{{\sum }_{i = 1}^{M} {\vert {A}_{i} \vert}^{2}} , \qquad Equation ( 5 )$$

Where Ai represents amplitude of frequency component I, and S_{N} represents a set of top N frequencies with the largest amplitude, M represents a total number of all frequency components, i.e., a total power of the time series data.

In some embodiments, if the energy ratio of the dominant frequency components exceeds a predetermined threshold (e.g., 10%, 30%, 50%, etc.), the workload is classified as seasonal; otherwise, the workload is considered non-seasonal, meaning no significant seasonality exists.

Notably, some workloads are seasonal, while others are non-seasonal. In response to determining that a workload is seasonal, the resource consumption forecasting module 270 is configured to forecast the workload's future resource consumption. In some embodiments, the dominant frequency components can be used to reconstruct future workload behavior. The resource consumption forecasting module 270 may apply an inverse Fourier transform to generate a predicted time series data that simulates and forecasts the real time series data.

Alternatively, or in addition, a time-series machine-learning model may be used to predict seasonal workload behavior. The time-series machine-learning model may be Chronos machine learning model. The model is trained transformer-based time-series forecasting model for probabilistic time-series forecasting. In some embodiments, the model is a deep neural network trained to predict future data points.

In some embodiments, the model transforms time-series data into sequences of tokens through scaling and quantization, and applies language modeling techniques, such as transformer based architectures, to these token sequences. The transformer based architectures may apply self-attention mechanisms to enable the model to learn long-range dependencies in time series data, similar to how transformers capture contextual meaning in text. This allows the model to model complex temporal dependencies across different time periods. In some embodiments, similar to autoregressive language models that predict a next word in a sentence, the model predicts a next time-step in a sequence based on previously observed values.

In some embodiments, the model is trained to predict a range of possible future values rather than a single deterministic outcome, such as 50^{th} percentile prediction, 90^{th} percentile prediction, 10^{th} percentile prediction, among others. Each workload may be set to be associated with a specific percentile prediction, and the autoscaler module 280 allocates resources for workloads based on their associated percentile predictions.

For example, the 50^{th} percentile forecast represents the median expected value. This means that 50% of the time the actual resource usage will be below this value, and 50% of the time it will be above it. It is considered the most probable estimate of the future demand. If the autoscaler module 280 follows the 50^{th} percentile forecast, it will allocate just enough resources to handle the expected workload, balancing efficiency and performance, but does not account for occasional spikes. If a forecast for 50^{th} percentile CPU load is 65%, there is a 50% chance that the actual demand will be below 65% and a 50% chance it will be above 65%. The autoscaler module 280 can allocate resources based on 65% expected CPU load.

As another example, the 90^{th} percentile forecast means that 90% of the time, actual resource usage will be below this value, and only 10% of the time, it will exceed it. This is a conservative approach, ensuring that resources are provisioned to handle occasional surges. This approach may be implemented when system reliability and performance are critical (e.g., banking apps, e-commerce flash sales). As such, under-provisioning caused slowdowns or failures will be significantly reduced. If a forecast for 90^{th} percentile CPU load is 120%, there is a 90% chance that the actual demand will be below 120% load and a 10% chance it will be above 120%. The autoscaler can allocate resources based on 120% expected CPU load, i.e., provisioning extra resources based on 65% expected CPU load.

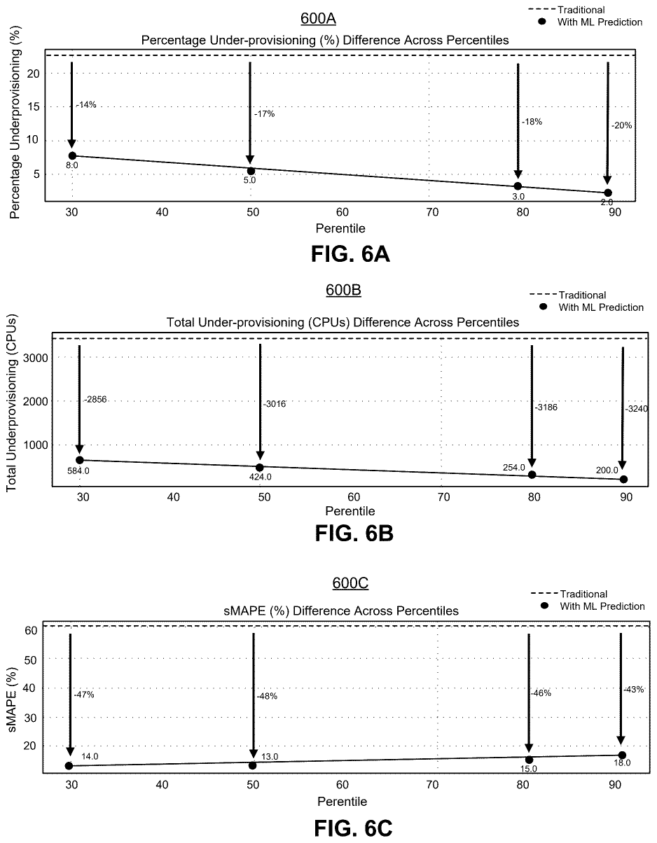

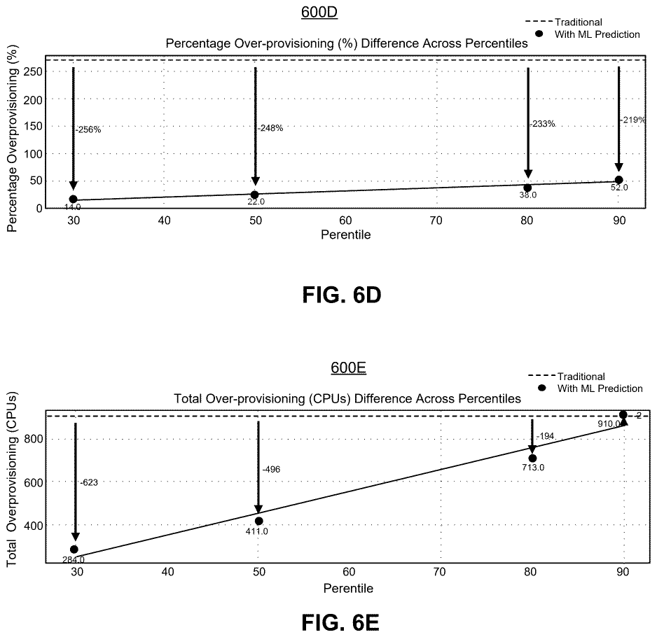

On the other hand, the 10^{th} percentile forecast means that 90% of the time actual resource usage will be higher than the predicted value, and only 10% of the time, it will be lower. This strategy may be used for non-critical workloads where occasional performance degradation is acceptable to save resources. Additional details about application of the machine learning model to forecast different percentiles of resource usage are further described below with respect to FIGS. 6A-6E.

The autoscaler module 280 is configured to automatically adjust resource allocation, such as virtual machines, containers, or pods based on seasonality of workload resource consumptions. Unlike traditional autoscalers, which operate on a reactive basis, the autoscaler module 280 described herein proactively allocates resources by leveraging detected seasonal patterns in workload consumption. Traditional autoscalers typically rely on real-time CPU, memory, or network usage thresholds, scaling resources only after demand has increased or decreased. This reactive approach often results in latency issues, where resources are not provisioned in time to handle sudden spikes, or over-provisioning, where excess resources remain allocated even when demand decreases.

By contrast, the autoscaler module 280 utilizes predictive resource allocation techniques, incorporating output of the seasonality detection module 230, which includes using transformations (such as Fourier Transform) analysis and/or transformer-based deep learning models to detect seasonality trends in resource usage. By identifying historical workload seasonality, the autoscaler module 280 can preemptively scale resources up or down in anticipation of future demand. This reduces the risk of performance degradation during high-traffic periods while preventing unnecessary cloud resource consumption when demand is expected to decline.

For example, if a workload exhibits daily peak usage between 9 AM and 12 PM, the autoscaler module 280 can increase resource allocation in advance at 8:45 AM, ensuring a seamless user experience. Similarly, if demand consistently decreases after 6 PM, the autoscaler can reduce allocated resources at 6:15 PM, optimizing cloud resource consumption without compromising availability.

In some embodiments, the autoscaler module 280 interfaces with Kubernetes Horizontal Pod Autoscaler (HPA) and Vertical Pod Autoscaler (VPA) to dynamically adjust both the number of active pods (horizontal scaling) and the compute resources allocated to each pod (vertical scaling). Through its proactive resource management approach, the autoscaler module 280 enables cloud environments to anticipate and adapt to workload demands more effectively, reducing response delays, improving resource consumption efficiency, and enhancing overall system reliability.

The metrics determination module 220 is configured to process the time series data collected by the data collection module 210 to determine metrics associated with resource consumption of workloads or pods. In some embodiments, the metrics determination module 220 is configured to process the data using a rolling window, e.g., a rolling 15-minute window. For example, for each pod or workload, the metrics determination module 220 may determine a maximum CPU usage or an average CPU usage of past time window, e.g., last 15 minutes. In some embodiments, metrics determination module 220 determines metrics related to under-provisioning and/or over-provisioning. In some embodiments, the metrics are determined periodically, e.g., every minute, every a few minutes, etc. In some embodiments, the metrics are determined at a frequency lower than the frequency at which data is collected by the data collection module 210. For example, the data collection module 210 collects data every 15 seconds, and the metrics determination module 220 determines metrics every 10 minutes.

For a given workload, under-provisioning occurs when an actual usage of resources exceeds a recommended resource allocation. An under-provisioning metric can be represented by the following Equation (1):

$$underprovisioning = \frac{n}{N} {{\sum }^{N}}_{i = 1} max ( {usage}_{i} - {recommendation}_{i} , 0 ) \qquad Equation ( 1 )$$

where usageᵢ represents an actual usage of resource, recommendation represents a corresponding recommended resource allocation, n represents a number of pods in a workload, N represents a total number of time points at which resource consumption and recommendations are measured.

The above equation provides raw values, which do not account for workload scale. The metrics determination module 220 may further normalize the raw value: the above metric is divided by the total actual usage, represented by the following Equation (2):

$$underprovisioning percentage = 100 \times \frac{{\sum }_{i = 1}^{N} max ( {usage}_{i} - {recommendation}_{i} , 0 ) )}{{\sum }_{i = 1}^{N} {usage}_{i}} \qquad Equation ( 2 )$$

If usage_i>recommendation_i, the under-provisioning is counted. If usage_i>=recommendation_i, no under-provisioning is counted.

Over-provisioning occurs when a recommended resource allocation exceeds actual usage. An over-provisioning metric can be measured by the following Equation (3):

$$overprovisioning = \frac{n}{N} {{\sum }^{N}}_{i = 1} max ( {recommendation}_{i} - {usage}_{i} , 0 ) \qquad Equation ( 3 )$$

where usage represents an actual usage of resource, recommendation represents a corresponding recommended resource allocation, n represents a number of pods in a workload, N represents a total number of time points at which resource consumption and recommendations are measured.

Similarly, the above metric is divided by the total usage to compute an under-provisioning percentage, represented by the following Equation (4):

$$overprovisioning percentage = 100 \times \frac{{\sum }_{i = 1}^{N} max ( {usage}_{i} - {recommendation}_{i} - {usage}_{i} , 0 )}{{\sum }_{i = 1}^{N} {usage}_{i}} \qquad Equation ( 4 )$$

If the system is consistently under-provisioned, i.e., the under-provisioning percentage is greater than a threshold, the workload may suffer from performance issues, slowdowns, or failures. If the system is consistently over-provisioned, i.e., the over-provisioning percentage is greater than a threshold, resources are idled, leading to inefficiencies.

In some embodiments, in addition to under-provisioning and over-provisioning metrics, the metrics determination module 220 may also determine other metrics, such as sMAPE (symmetric mean absolute percentage error), RMSE (root mean square error), and MAE (mean absolute error), to evaluate the accuracy of the resource consumption forecasting module 270's forecast about resource usages, e.g., CPU usages.

In some embodiments, sMAPE may be determined based on the following Equation (7):

$$sMAPE = \frac{1}{N} {{\sum }^{N}}_{i = 1} \frac{\vert {F}_{i} - {A}_{i} \vert}{( \vert {F}_{i} \vert + \vert {A}_{i} \vert ) / 2} \times 100 , \qquad Equation ( 7 )$$

where Fi represents forecasted resource usage (e.g., predicted CPU usage), Ai represents actual resource usage (actual CPU usage), and N represents a total number of observations.

sMAPE measures the percentage error in forecasts. A lower sMAPE indicates better forecasting accuracy. In some embodiments, sMAPE may be calculated for different percentile-based forecasts (e.g., 50^{th} percentile, 80^{th} percentile predictions).

In some embodiments, RMSE may be determined based on the following equation (8):

$$RMSE = \sqrt{\frac{1}{N} {{\sum }^{N}}_{i = 1} {( {F}_{i} - {A}_{i} )}^{2}} , \qquad Equation ( 8 )$$

where Fi represents forecasted resource usage (e.g., predicted CPU usage), Ai represents actual resource usage (actual CPU usage), and N represents a total number of observations.

RMSE measures the average squared error in predictions. It penalizes larger errors more heavily than MAE. A lower RMSE indicates better accuracy. RMSE helps identify high-variance errors.

In some embodiments, MAE may be determined based on the following Equation (9):

$$MAE = \frac{1}{N} {{\sum }_{i = 1}}^{N} \vert {F}_{i} - {A}_{i} \vert , \qquad Equation ( 10 )$$

where Fi represents forecasted resource usage (e.g., predicted CPU usage), Ai represents actual resource usage (actual CPU usage), and N represents a total number of observations.

MAE measures an average absolute difference between forecasted and actual values. Unlike RMSE, it does not heavily penalize large deviations. A lower MAE indicates better overall prediction accuracy. MAE may be used alongside RMSE to determine if errors are systematically high or low.

These metrics can be used to assess the accuracy of the resource consumption forecasting module 270's prediction. They can also be used to guide autoscaler module 280 to scale up or down.

The feedback module 290 is configured to take various feedback, which may include (but is not limited to) the metrics determined by the metrics determination module 220, user feedback input by users, among others. Some of the feedback may be used to retrain or adjust machine-learning model's parameters. For example, if under-provisioning is too frequent, the system may shift autoscaling decision to a higher percentile (e.g., 80^{th} percentile prediction instead of 50^{th} percentile). On the other hand, if over-provisioning is too high, the system can recommend more aggressive scaling down to reduce inefficiencies in resource provisioning.

In some embodiments, manually input feedback allow operators to fine-tune predictions based on real-world observations or preferences. For example, a cloud administrator might override predictions if a known vent (e.g., a holiday scale or software update) is expected to cause abnormal traffic surges. Users may also provide insights into false positives or false negatives in resource scaling, allowing manual correction of mispredictions. If Chronos predictions underperform for certain workloads, users can adjust threshold values to improve autoscaling strategies.

### Example Time-Series Workload CPU Usage

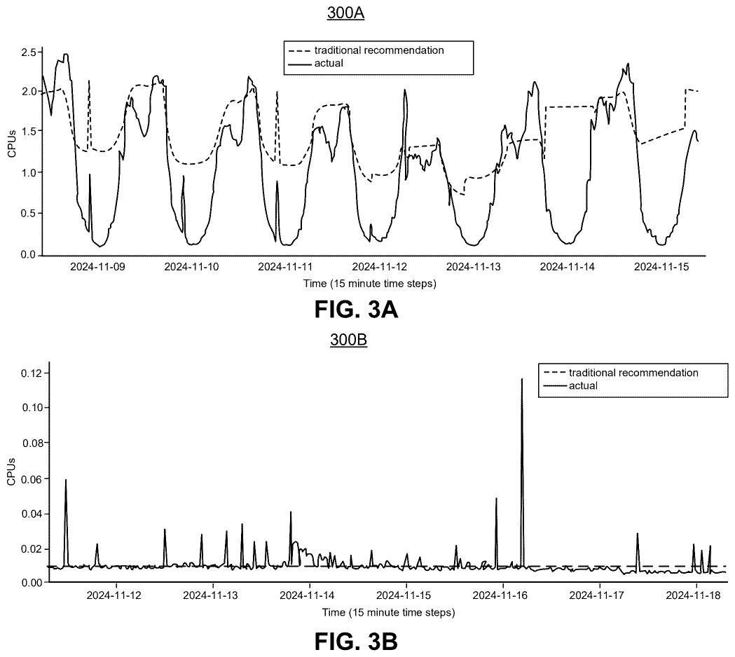

FIG. 3A illustrates an example time-series plot 300A of a workload CPU usage and a corresponding resource allocation recommendation generated by an existing optimization system, in accordance with one or more embodiments. As illustrated, the CPU usage line shown in FIG. 3A exhibits strong periodicity, meaning that there are clear, repeating cycles in the workload demand. The existing optimization system recommendation line follows a pattern but lags significantly from the real workload demand. This is because the existing optimization system is reactive rather than predictive.

FIG. 3B illustrates another example time-series plot 300B of a workload CPU usage and a corresponding resource allocation recommendation generated by the existing optimization system, in accordance with one or more embodiments. Contrary to the pattern shown in FIG. 3A, the CPU usage here is erratic and does not exhibit clear cycles. The existing optimization system also fails to recommend different resource allocation at different times to handle the resource demand spikes shown in FIG. 3B.

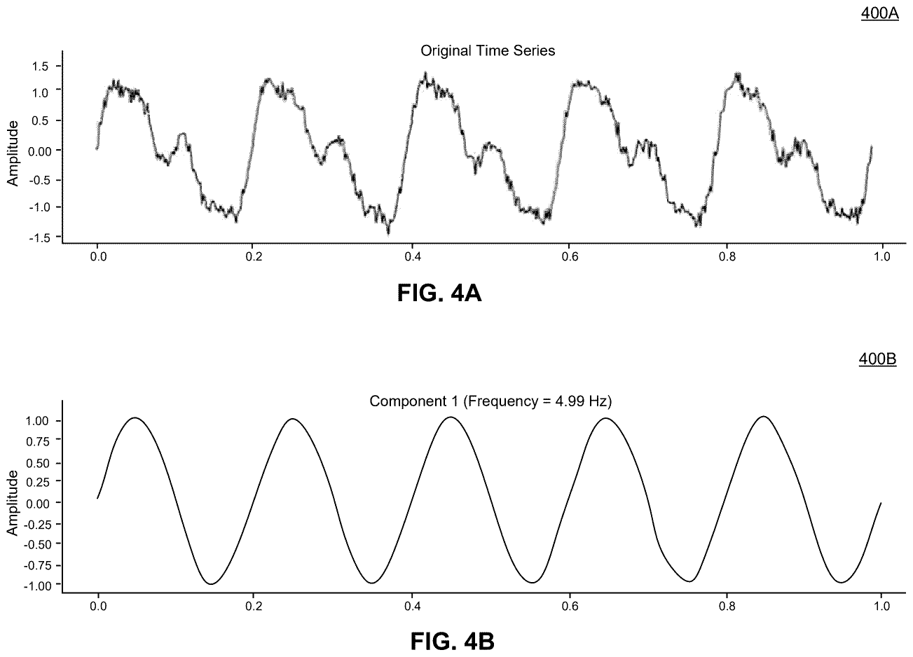

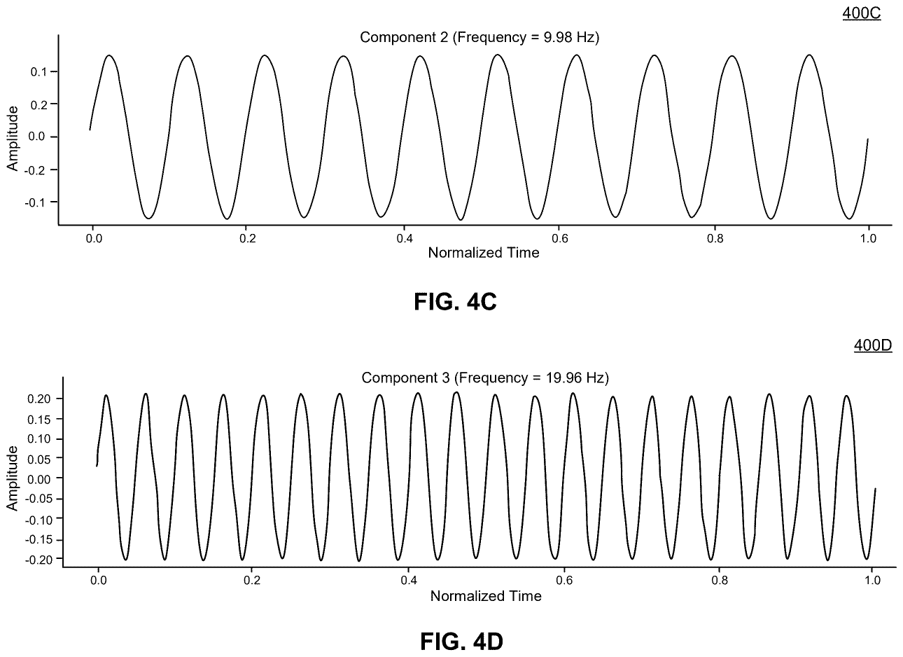

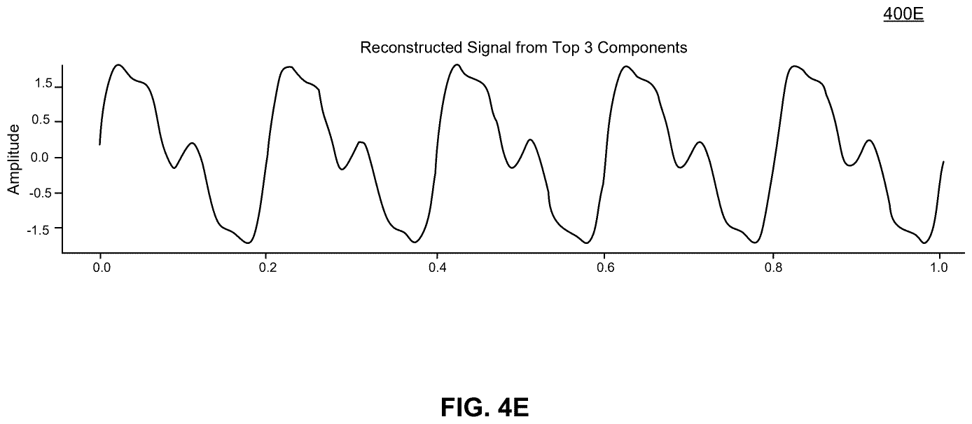

Unlike the existing optimization system, the seasonality detection module 230 described herein applies Fourier transform to each of these different workload time series, which may be corresponding to CPU usage, GPU usage, memory usage, disk I/O, network bandwidth, and/or other resource usage metrics, to decompose a time-series signal into its dominant frequency components, i.e., sinusoidal waves. FIGS. 4A-4E illustrate an example workload CPU usage time-series being divided into multiple frequency components, which can then be combined together to predict future workload CPU usage.

FIG. 4A illustrates time series 400A corresponding to a workload CPU usage, in accordance with some embodiments. FIGS. 4B-4D illustrate sinusoidal waves 400B, 400C, 400D corresponding to top three frequency components extracted from the time series 400A of the workload CPU usage. As illustrated, the original time series 400A has an amplitude oscillating between +1.5 and −1.5 (shown in FIG. 4A); the first component has a frequency of 4.99 Hz and an amplitude oscillating between +1.0 and −1.0 (shown in FIG. 4B); the second component has a frequency of 9.98 Hz and an amplitude oscillating between +0.8 and −0.8 (shown in FIG. 4C); and the third component has a frequency of 19.98 Hz and an amplitude oscillating between +0.3 and −0.3 (shown in FIG. 4D).

Based on the amplitude of each frequency component, a power magnitude can be computed for each frequency component based on the following Equation (6):

$$P = {0.5}^{*} {A}^{2} \qquad Equation ( 6 )$$

where A is the amplitude, and P is the power magnitude.

For example, the frequency component shown in FIG. 4B corresponds to a power magnitude of 0.5 (=0.5*1²); the frequency component shown in FIG. 4C corresponds to a power magnitude of 0.32 (=0.5*0.8²); and the frequency component shown in FIG. 4D corresponds to a power magnitude of 0.045 (=0.5*0.3²). Based on these power magnitudes of the top three frequency components and a total power of the original time series (shown in FIG. 4A), an energy ratio of the top three frequency components can be determined.

The workload seasonality determination module 250 also determines whether the energy ratio is greater than a predetermined threshold (e.g., 80%). In response to determining that the energy ratio of the top a few frequency components are greater than the predetermined threshold, the workload seasonality determination module 240 determines that the workload is seasonal.

In response to determining that the workload is seasonal, the resource consumption forecasting module 270 may apply an inverse Fourier transform to the top three frequency components to generate a forecast time series, which can be used to forecast future resource consumptions. FIG. 4E illustrates a forecasting time series 400E of a predicted workload CPU usage that combines the top three frequency components 400B, 400C, 400D extracted from the time series 400A, in accordance with one or more embodiments. Notably, the forecasting time series 400E resembles the original time series 400A closely. This forecasting time series 400E can be used to predict future workload resource usage, and guide autoscaler module 280 to proactively scale resources.

As shown in FIGS. 4A-4E a few top frequency components of a workload has a high energy ratio (e.g., greater than 80%), the few top frequency components can effectively reconstruct the original time series, providing highly accurate predictions.

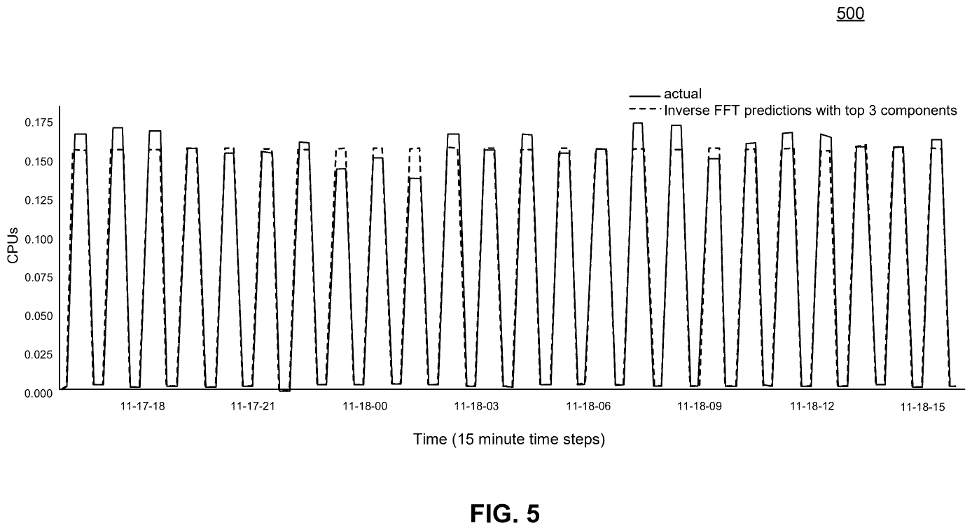

FIG. 5 illustrates another example time series 500 of a workload with strong seasonality, such that the forecasting time series closely resembles the original time series, in accordance with one or more embodiments. In FIG. 5, the energy ratio of the top few frequency components is 98%, indicating that most of the variance in the workload CPU usage can be explained by just the top few frequency component. The actual time series line and the forecasting time series line closely align with each other.

FIGS. 6A-6E illustrates comparative performance metrics between recommendations generated by existing systems and recommendations generated based on transformer-based predictions for resource provisioning in accordance with one or more embodiments. Each vertical arrow line (from left to right) corresponds to the 30^{th} percentile, 50^{th} percentile, 80^{th} percentile, and 90^{th} percentile.

FIG. 6A is a plot 600A depicting percentage under-provisioning differences between existing system and Chrono-based system across different percentiles. As described above, under-provisioning measures how often the system does not allocate enough CPU resources, leading to performance issues. FIG. 6A shows that transformer-based predictions reduce under-provisioning significantly across all percentiles. The vertical arrows indicate the reduction in under-provisioning as percentile values increase.

FIG. 6B is a plot 600B depicting unit number under-provisioning differences between existing system and Chrono-based system across different percentile. Similar to FIG. 6A, transformer-based recommendations show lower under-provisioning compared to the existing system. Numbers above the vertical arrows (e.g., 2986, 3104) indicate how many CPU under-provisions observed at different percentiles. Lower values in transformer-based prediction indicate better workload handling.

FIG. 6C is a plot 600C depicting percentage sMAPE (symmetric Mean Absolute Percentage Error) differences between existing system and Chrono-based system across different percentiles. Lower sMAPE means better performance. The transformer-based system shows a much lower sMAPE across percentiles, indicating that transformer-based system provides a much more reliable forecasts for resource usage.

FIG. 6D a plot 600D depicting percentage over-provisioning differences between existing system and Chrono-based system across different percentiles. As described above, over-provisioning measures how often the system allocates CPUs, exceeding actual needs, leading to inefficiencies. FIG. 6D shows that transformer-based system reduces over-provisioning significantly across different percentiles.

FIG. 6E is a plot 600E depicting unit number over-provisioning differences between existing system and Chrono-based system across different percentile. Similar to FIG. 6D, transformer-based system shows a more controlled increase in over-provisioning at higher percentiles compared to the existing system.

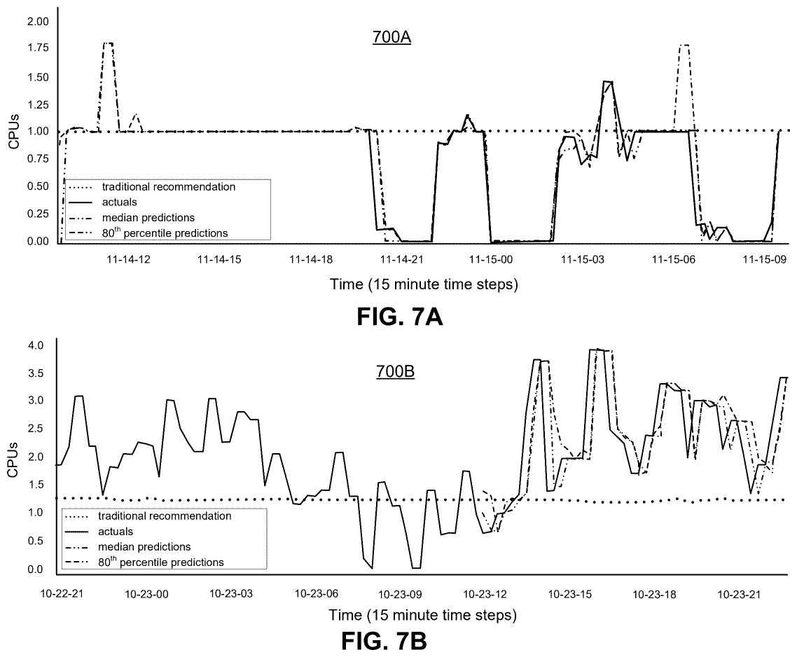

FIG. 7A is a plot 700A depicting a workload with intermittent CPU usage with sharp spikes and long idled periods. The existing recommendation maintains a static CPU allocation, failing to adapt to fluctuating demand. In contrast the transformer-based system closely tracks the actual workload consumption, anticipating sudden surges and periods of inactivity. Notably, during idle periods, transformer-based system predicts near-zero CPU usage, aligning with actual data, while the static existing system results in resource over-provisioning. During high-demand moments, the 80^{th} percentile forecast effectively captures peak CPU spikes, which helps prevent under-provisioning.

FIG. 7B is a plot 700B depicting another highly dynamic workload, where CPU demand remains consistently high with some variations. The existing system recommendation remains flat and fails to react to the volatility in CPU consumption, potentially leading to performance degradation during demand spikes and wasteful over-provisioning during lower-demand intervals. In contrast, the transformer-based system tracks the rapid workload fluctuation with high accuracy, adjusting to workload surges and dips. The 80^{th} percentile prediction effectively captures peak resource demands. These examples demonstrate that transformer-based predictive forecasting system offers a much more adaptive, intelligent resource management solution, improving the functioning of the computing systems.

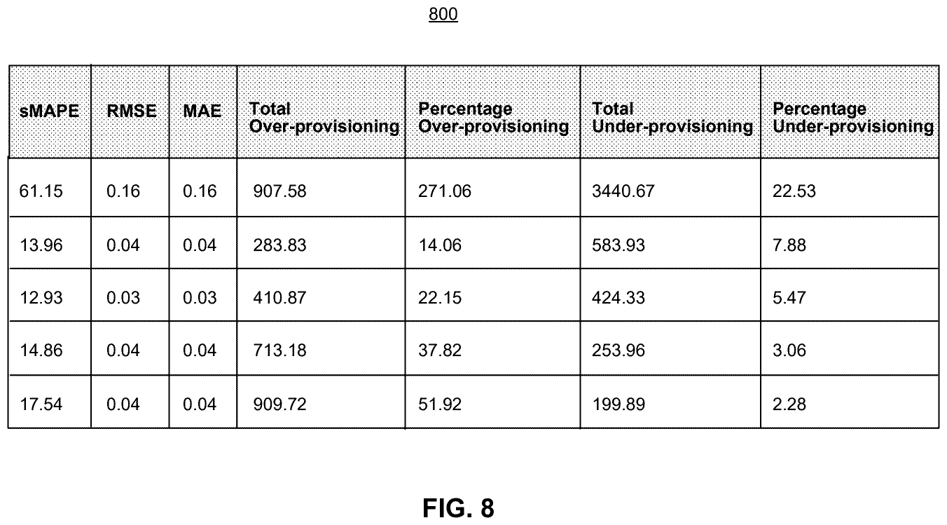

FIG. 8 is a table 800, presenting a quantitative evaluation of forecasting accuracy and resource allocation efficiency of the forecasting system described herein, comparing key performance metrics across at different time periods, in accordance with one or more embodiments. The table includes sMAPE (symmetric mean absolute percentage error), RMSE (root mean square error), and MAE (mean absolute error)—which are metrics for measuring predictive accuracy. Lower values for RMSE and MAE indicate higher precision in workload forecasting. Additionally, the table evaluates total and percentage over-provisioning and total and percentage under-provisioning, which are key indicators of resource allocation efficiency.

Each row represents data points from different time periods. At the beginning (first few rows), the system may not have sufficient time-series data to accurately forecast future resource consumption. As time goes on (the last few rows), the system accumulates more time-series data, thereby improving its ability to accurately forecast future resource consumption. The first row shows a high sMAPE (61.15), indicating poor predictive accuracy, which results in significant total under-provisioning (3440.67) and over-provisioning (907.58). However, as we move down the table, sMAPE decreases, and prediction errors (RMSE and MAE) also decrease, suggesting improvements in forecasting accuracy. The last row, with an sMAPE of 17.54 and the lowest under-provisioning percentage (2.28%), demonstrates a more balanced and efficient resource allocation strategy, minimizing both wasted capacity and performance risks. This suggests that more accurate predictive models (e.g., transformer-based approaches) can gradually enhance workload management by reducing over- and under-provisioning of resources, leading to optimized cloud resource utilization.

### Example Methods for Proactively Optimizing Resource Allocation Based on Seasonality

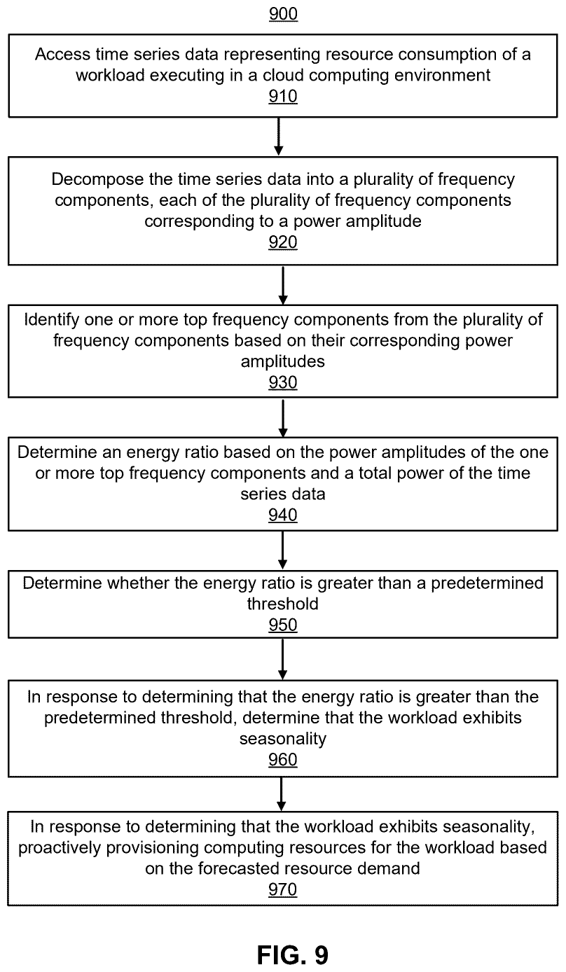

FIG. 9 is a flowchart of a method 900 for proactively optimizing resource allocation based on seasonality in a cloud computing environment, in accordance with one or more embodiments. In various embodiments, the method includes different or additional steps than those described in conjunction with FIG. 9. Further, in some embodiments, the steps of the method may be performed in different orders than the order described in conjunction with FIG. 9. The method described in conjunction with FIG. 9 may be carried out by the automation system 110 in various embodiments, while in other embodiments, the steps of the method are performed by any online system capable of performing these steps.

The automation system 110 accesses 910 time series data representing resource consumption of a workload executing in a cloud computing environment. The time series data may be collected by the data collection module 210 described above with respect to FIG. 2. The time-series data may include historical resource usage metrics such as CPU utilization, GPU utilization, memory consumption, disk I/O, and network bandwidth over a specified period.

The automation system 110 decomposes 920 the time series data into a plurality of frequency components. In some embodiments, decomposing 920 the time series data may include applying Fourier transform onto the time series data to decompose the time series data into the plurality of frequency components. Each of the plurality of frequency components corresponds to a power magnitude. One or more top frequency components is identified 930 from the plurality of frequency components based on their corresponding power magnitudes. An energy ratio is determined 940 based on the power magnitudes of the one or more top frequency components and a total power of the time series data. The automation system determines 950 whether the energy ratio is greater than a predetermined threshold, e.g., 20%, 50%, 80%. In response to determining that the energy ratio is greater than the predetermined threshold, it is determined 960 that the workload exhibits seasonality. In some embodiments, the steps 920 through 960 may be performed by the seasonality detection module 230 described above with respect to FIG. 2.

In response to determining that the workload exhibits seasonality, the automation system 110 proactively provisioning 970 computing resources for the workload based on the forecasted resource demand. In some embodiments, proactively provisioning 970 computing resources includes forecasting the resource demand. In some embodiments, forecasting the resource demand may be based on applying an inverse Fourier Transform to reconstruct a forecasted time series data based on the one or more top frequency components. Alternatively, or in addition, forecasting the resource demand includes applying a transformer-based time-series model (e.g., Chronos model) to the time series data to predict future resource consumption. In some embodiments, the transformer-based time-series model is trained to forecast resource demand at multiple percentiles, e.g., 90^{th} percentile, 80^{th} percentile, 50^{th} percentile, etc.

In some embodiments, proactively provisioning computing resources for the workload includes dynamically adjusting, by a Kubernetes Autoscaler, such as horizontal pod autoscaler (HPA) and/or a vertical pod autoscaler (VPA), resource allocation for workloads in a Kubernetes cluster. In some embodiments, proactive provisioning computing resources for the workload is based on forecasted resource demand at one of the multiple percentiles. The percentile selection may be based on the nature of the workload, e.g., how critical the workload is. The more critical the work load is, the higher percentile may be selected for forecasting future resource consumption. For example, a online banking application's workload may use 90th resource demand to predict its future resource consumption.

In some embodiments, the steps 910 through 970 are performed iteratively. In some embodiments, the steps 910 through 970 are performed periodically at a predetermined frequency to adaptively provision computing resources for each of multiple workloads. As such, the forecasting continuously improves and adapts to recent resource consumption of workloads.

In some embodiments, the automation system 110 monitors the difference between actual computing resource consumption and provisioned computing resources, determines various metrics associated with resource consumption. The determination of the metrics may be performed by the metrics determination module 220 described above with respect to FIG. 2.

The metrics associated with resource consumption may include an under-provisioning metric indicating the frequency at which actual resource consumption exceeds provisioned resources at different times. Alternatively, or in addition, the metrics determination module 220 determines an over-provisioning metric indicating the frequency at which provisioned resources exceed actual resource consumption. The metrics may also include (but are not limited to) sMAPE, RMSE, and/or MAE.

In some embodiments, these metrics may be used by the automation system 110 as feedback to adjust a percentile for provisioning computing resources. In some embodiments, these metrics may be used to adjust parameters of the machine learning model to improve its forecast accuracies.

### Example Computing System

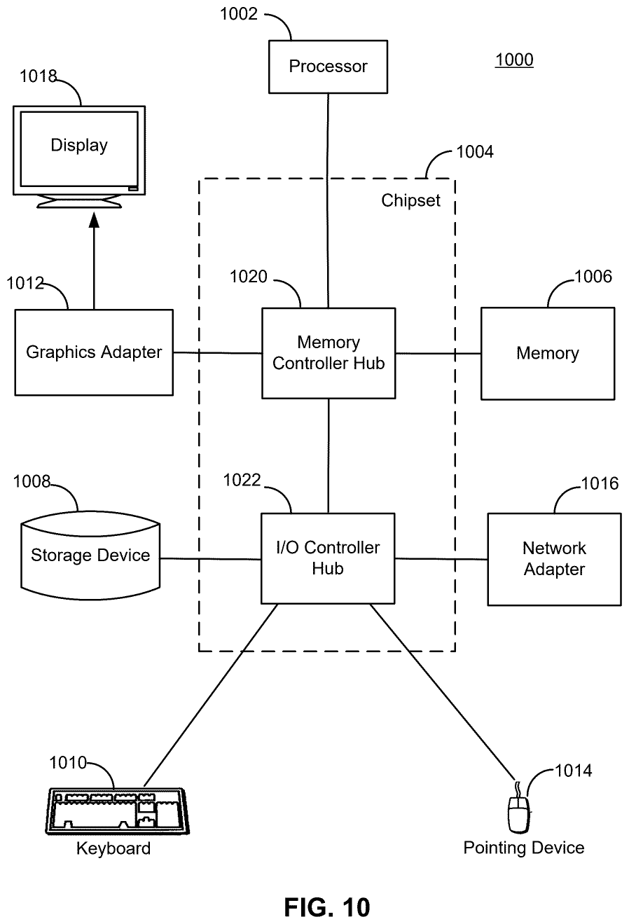

FIG. 10 is a block diagram of an example computer 1000 suitable for use in the networked computing environment 100 of FIG. 1. The computer 1000 is a computer system and is configured to perform specific functions as described herein. For example, the specific functions corresponding to automation system 110 may be configured through the computer 1000.

The example computer 1000 includes a processor system having one or more processors 1002 coupled to a chipset 1004. The chipset 1004 includes a memory controller hub 1020 and an input/output (I/O) controller hub 1022. A memory system having one or more memories 1006 and a graphics adapter 1012 are coupled to the memory controller hub 1020, and a display 1018 is coupled to the graphics adapter 1012. A storage device 1008, keyboard 1010, pointing device 1014, and network adapter 1016 are coupled to the I/O controller hub 1022. Other embodiments of the computer 1000 have different architectures.

In the embodiment shown in FIG. 10, the storage device 1008 is a non-transitory computer-readable storage medium such as a hard drive, compact disk read-only memory (CD-ROM), DVD, or a solid-state memory device. The memory 1006 holds instructions and data used by the processor 1002. The pointing device 1014 is a mouse, track ball, touchscreen, or other types of a pointing device and may be used in combination with the keyboard 1010 (which may be an on-screen keyboard) to input data into the computer 1000. The graphics adapter 1012 displays images and other information on the display 1018. The network adapter 1016 couples the computer 1000 to one or more computer networks, such as network 150.

The types of computers used by the entities and the automation system 110 of FIGS. 1 through 8 can vary depending upon the embodiment and the processing power required by the enterprise. For example, the automation system 110 might include multiple blade servers working together to provide the functionality described. Furthermore, the computers can lack some of the components described above, such as keyboards 1010, graphics adapters 1012, and displays 1018.

### ADDITIONAL CONSIDERATIONS

The embodiments described herein enable proactive, intelligent resource management in cloud computing environments through seasonality-aware forecasting. Unlike traditional reactive autoscaling approaches that adjust resources only after workload demand has changed, the embodiments described herein anticipates future resource consumption patterns by analyzing historical time-series data and identifying dominant frequency components using Fourier Transform techniques. By computing an energy ratio, the system can accurately determine whether a workload exhibits seasonal behavior, allowing for predictive provisioning of compute resources. This approach significantly reduces under-provisioning, which can cause performance degradation and system failures, as well as over-provisioning, which leads to wasted computational resources and increased operational efficiency.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
accessing time series data representing resource consumption of a workload executing in a cloud computing environment;
decomposing the time series data into a plurality of frequency components, each of the plurality of frequency components corresponding to a power magnitude;
identifying one or more top frequency components from the plurality of frequency components based on their corresponding power magnitudes;
determining an energy ratio based on the power magnitudes of the one or more top frequency components and a total power of the time series data; and
determining whether the energy ratio is greater than a predetermined threshold; and
in response to determining that the energy ratio is greater than the predetermined threshold, determining that the workload exhibits seasonality; and
in response to determining that the workload exhibits seasonality, proactively provisioning computing resources for the workload based on the seasonality.

2. The method of claim 1, wherein identifying the one or more top frequency components includes:
sorting the plurality of frequency components by power magnitude in descending order; and
selecting a predetermined amount of highest-power magnitude frequency components.

3. The method of claim 1, wherein decomposing the time series data into a plurality of frequency components comprises applying a Fourier Transform to the time series data to determine the plurality of frequency components, and
wherein proactively provisioning computing resources for the workload based on the seasonality comprises applying an inverse Fourier Transform to reconstruct a forecasted time series data based on the one or more top frequency components.

4. The method of claim 1, wherein proactively provisioning computing resources for the workload based on the seasonality includes applying a transformer-based time-series model to forecast computing resource demand of the workload at a plurality of percentiles.

5. The method of claim 4, wherein proactively provisioning computing resources for the workload is based on the forecasted computing resource demand at one of the plurality of percentiles.

6. The method of claim 5, further comprising:
monitoring a difference between actual computing resource consumption and a provisioned computing resource;
determining an over-provisioning metric indicating a frequency of a provisioned resource exceeds an actual resource consumption in the time series data;
determining a percentile different from a current percentile used for provisioning computing resources for the workload based on the over-provisioning metric; and
proactively provisioning computing resources for the workload based on the determined percentile.

7. The method of claim 5, further comprising:
monitoring a difference between actual computing resource consumption and a provisioned computing resource;
determining an under-provisioning metric indicating a frequency of an actual resource consumption exceeds a provisioned resource at different times;
determining a percentile different from a current percentile used for provisioning computing resources for the workload based on the under-provisioning metric; and
proactively provisioning computing resources for the workload based on the determined percentile.

8. The method of claim 1, wherein for a given workload:
periodically determining whether the workload exhibits seasonality;
in response to each such determination of whether the workload exhibits seasonality,
inputting the time series data of the workload into a pretrained machine-learning forecasting model to output a predicted resource demand; and
dynamically provisioning computing resources for the workload based on the predicted resource demand.

9. The method of claim 1, wherein time series data representing resource consumption of the workload includes one or more of time series data representing central processing unit (CPU) consumption, graphics processing unit (GPU) consumption, memory consumption, disk I/O (input/output), or network bandwidth.

10. The method of claim 1, wherein proactively provisioning computing resources for the workload comprises:
dynamically adjusting, by a Kubernetes Autoscaler, resource allocation for workloads in a Kubernetes cluster.

11. A non-transitory computer readable storage medium having instructions encoded thereon that, when executed by one or more processors, cause the one or more processors to perform steps comprising:
accessing time series data representing resource consumption of a workload executing in a cloud computing environment;
decomposing the time series data into a plurality of frequency components, each of the plurality of frequency components corresponding to a power magnitude;
identifying one or more top frequency components from the plurality of frequency components based on their corresponding power magnitudes;
determining an energy ratio based on the power magnitudes of the one or more top frequency components and a total power of the time series data; and
determining whether the energy ratio is greater than a predetermined threshold; and
in response to determining that the energy ratio is greater than the predetermined threshold, determining that the workload exhibits seasonality; and
in response to determining that the workload exhibits seasonality, proactively provisioning computing resources for the workload based on the seasonality.

12. The non-transitory computer readable storage medium of claim 11, wherein identifying the one or more top frequency components includes:
sorting the plurality of frequency components by power magnitude in descending order; and
selecting a predetermined number of highest-power frequency components.

13. The non-transitory computer readable storage medium of claim 11, wherein decomposing the time series data into a plurality of frequency components comprises applying a Fourier Transform to the time series data to determine the plurality of frequency components, and
wherein proactively provisioning computing resources for the workload based on the seasonality comprises applying an inverse Fourier Transform to reconstruct a forecasted time series data based on the one or more top frequency components.

14. The non-transitory computer readable storage medium of claim 11, wherein proactively provisioning computing resources for the workload based on the seasonality includes applying a transformer-based time-series model to forecast computing resource demand of the workload at a plurality of percentiles.

15. The non-transitory computer readable storage medium of claim 14, wherein proactively provisioning computing resources for the workload is based on the forecasted computing resource demand at one of the plurality of percentiles.

16. The non-transitory computer readable storage medium of claim 15, the steps further comprising:
monitoring a difference between actual computing resource consumption and a provisioned computing resource;
determining an over-provisioning metric indicating a frequency of a provisioned resource exceeds an actual resource consumption in the time series data;
determining a percentile different from a current percentile used for provisioning computing resources for the workload based on the over-provisioning metric; and
proactively provisioning computing resources for the workload based on the determined percentile.

17. The non-transitory computer readable storage medium of claim 15, the steps further comprising:
monitoring a difference between actual computing resource consumption and a provisioned computing resource;
determining an under-provisioning metric indicating a frequency of an actual resource consumption exceeds a provisioned resource at different times;
determining a percentile different from a current percentile used for provisioning computing resources for the workload based on the under-provisioning metric; and
proactively provisioning computing resources for the workload based on the determined percentile.

18. The non-transitory computer readable storage medium of claim 11, wherein following steps are performed at a predetermined frequency to adaptively provision computing resources for each of a plurality of workloads:
periodically determining whether the workload exhibits seasonality;
in response to each such determination of whether the workload exhibits seasonality,
inputting the time series data of the workload into a pretrained machine-learning forecasting model to output a predicted resource demand; and
dynamically provisioning computing resources for the workload based on the predicted resource demand.

19. The non-transitory computer readable storage medium of claim 11, wherein time series data representing resource consumption of the workload includes one or more of time series data representing central processing unit (CPU) consumption, graphics processing unit (GPU) consumption, memory consumption, disk I/O (input/output), or network bandwidth.

20. A system, comprising:
one or more processors; and
a non-transitory computer readable storage medium having instructions encoded thereon that, when executed by the one or more processors, cause the one or more processors to perform steps comprising:
accessing time series data representing resource consumption of a workload executing in a cloud computing environment;
decomposing the time series data into a plurality of frequency components, each of the plurality of frequency components corresponding to a power magnitude;
identifying one or more top frequency components from the plurality of frequency components based on their corresponding power magnitudes;
determining an energy ratio based on the power magnitudes of the one or more top frequency components and a total power of the time series data; and
determining whether the energy ratio is greater than a predetermined threshold; and
in response to determining that the energy ratio is greater than the predetermined threshold, determining that the workload exhibits seasonality; and
in response to determining that the workload exhibits seasonality, proactively provisioning computing resources for the workload based on the seasonality.
